(19) United States
(12) Patent Application Publication
(10) Pub. No.: US 2016/0253605 A1
(43) Pub. Date: Sep. 1, 2016

(54) METHOD AND SYSTEM FOR ANALYZING PERFORMANCE OF CROWDSOURCING SYSTEMS

(71) Applicant: XEROX CORPORATION, Norwalk, CT (US)

(72) Inventors: Guangyu Zou, Liaoning (CN); Haengju Lee, Webster, NY (US); David R. Vandervort, Walworth, NY (US)

(21) Appl. No.: 14/632,111

(22) Filed: Feb. 26, 2015

(51) Int. Cl. G06Q 10/06; G06Q 50/00

(52) U.S. Cl. CPC G06Q 10/0633; G06Q 10/06316; G06Q 50/01

(57) ABSTRACT

The disclosed embodiments illustrate methods and systems for determining strategies in crowdsourcing. The method includes generating first graphs representative of an association between workers, between crowdsourcing tasks, or between workers and crowdsourcing tasks, at first time instance. The method includes determining values of metrics associated with first graphs, comparing determined values of metrics and threshold values of metrics, and generating second graphs based on comparison. The second graphs are representative of an association between workers, between crowdsourcing tasks, or between workers and crowdsourcing tasks, at second time instance. The second time instance precedes first time instance. Thereafter, the method includes determining strategies based on second graphs. The strategies comprise recommendation to a first set of workers for attempting a first set of crowdsourcing tasks or recommendation to first set of workers for increasing interaction with second set of workers. The method is performed by one or more microprocessors.

### TECHNICAL FIELD

The presently disclosed embodiments are related, in general, to crowdsourcing. More particularly, the presently disclosed embodiments are related to methods and systems for determining strategies for improving the performance of crowdsourcing tasks.

### BACKGROUND

Crowdsourcing platforms provide an online job market where workers may connect to a crowdsourcing platform server and execute tasks posted by requesters. There may exist numerous workers for executing tasks on the crowdsourcing platforms. For example, on a crowdsourcing platform, multiple workers may work on the same task. This may lead to indirect interactions among the workers. Further, many workers may communicate and collaborate with each other, causing direct interactions.

Generally, the performance of a crowdsourcing system may be evaluated based on a set of parameters, for example, worker availability, remuneration, and compensation strategy. In addition, a set of metrics, for example, mean completion time and mean accuracy, may also be analyzed. However, these parameters and metrics may not be sufficient for determining the scope of improvement of the crowdsourcing system performance. Moreover, the existing evaluation methods may not take into account behavior of the workers. In an embodiment, the behavior of the workers may include choosing tasks with high remuneration and interacting with the other workers in a specific way.

### SUMMARY

According to embodiments illustrated herein, there is provided a method for determining one or more strategies in crowdsourcing. The method includes generating one or more first graphs representative of at least one of an association between one or more workers, between one or more crowdsourcing tasks, or between said one or more workers and said one or more crowdsourcing tasks, at a first time instance. The method further includes determining values of one or more metrics associated with said one or more first graphs. Further, the method includes comparing said determined values of said one or more metrics and one or more threshold values of said one or more metrics. The method further includes generating one or more second graphs based on said comparison. The one or more second graphs are representative of at least one of an association between said one or more workers, between said one or more crowdsourcing tasks, or between said one or more workers and said one or more crowdsourcing tasks, at a second time instance. The second time instance precedes said first time instance. The method further includes determining said one or more strategies based on said one or more second graphs. The one or more strategies comprise at least one of a recommendation to a first set of workers, from said one or more workers, for attempting a first set of crowdsourcing tasks, from said one or more crowdsourcing tasks, or a recommendation to said first set of workers for increasing interaction with a second set of workers. The method further includes displaying by a display screen said one or more strategies to a user through a user interface. The method is performed by one or more microprocessors.

According to embodiments illustrated herein, there is provided a system for determining one or more strategies in crowdsourcing. The system includes one or more microprocessors configured to generate one or more first graphs representative of at least one of an association between one or more workers, between one or more crowdsourcing tasks, or between said one or more workers and said one or more crowdsourcing tasks, at a first time instance. The one or more microprocessors are configured to determine values of one or more metrics associated with said one or more first graphs. The one or more microprocessors are further configured to compare said determined values of said one or more metrics and one or more threshold values of said one or more metrics. Further, the one or more microprocessors are configured to generate, one or more second graphs based on said comparison. The one or more second graphs are representative of at least one of an association between said one or more workers, between said one or more crowdsourcing tasks, or between said one or more workers and said one or more crowdsourcing tasks, at a second time instance. The second time instance precedes said first time instance. The one or more microprocessors are further configured to determine said one or more strategies based on said one or more second graphs. The one or more strategies comprise at least one of a recommendation to a first set of workers, from said one or more workers, for attempting a first set of crowdsourcing tasks, from said one or more crowdsourcing tasks, or a recommendation to said first set of workers for increasing interaction with a second set of workers. Thereafter, a display screen is configured to display said one or more strategies to a user through a user interface.

According to embodiments illustrated herein, there is provided a computer program product for use with a computing device. The computer program product comprises a non-transitory computer readable medium, the non-transitory computer readable medium stores a computer program code for determining one or more strategies in crowdsourcing. The computer program code is executable by one or more microprocessors to generate one or more first graphs representative of at least one of an association between one or more workers, between one or more crowdsourcing tasks, or between said one or more workers and said one or more crowdsourcing tasks, at a first time instance. The computer program code is further executable by the one or more microprocessors to determine values of one or more metrics associated with said one or more first graphs. The computer program code is further executable by the one or more microprocessors to compare said determined values of said one or more metrics and one or more threshold values of said one or more metrics. The computer program code is further executable by the one or more microprocessors to generate one or more second graphs based on said comparison. The one or more second graphs are representative of at least one of an association between said one or more workers, between said one or more crowdsourcing tasks, or between said one or more workers and said one or more crowdsourcing tasks, at a second time instance. The second time instance precedes said first time instance. The computer program code is further executable by the one or more microprocessors to determine said one or more strategies based on said one or more second graphs. The one or more strategies comprise at least one of a recommendation to a first set of workers, from said one or more workers, for attempting a first set of crowdsourcing tasks, from said one or more crowdsourcing tasks, or a recommendation to said first set of workers for increasing interaction with a second set of workers. The computer program code is further executable by a display screen to display said one or more strategies to a user through a user interface.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram illustrating a computing device for determining one or more strategies in crowdsourcing, in accordance with at least one embodiment;

FIG. 3 is a flowchart illustrating a method for determining the one or more strategies of crowdsourcing one or more tasks, in accordance with at least one embodiment;

FIG. 4A is a graph illustrating an association between the workers and the crowdsourcing tasks, in accordance with at least one embodiment;

FIG. 4B is a graph illustrating an association between the crowdsourcing tasks, in accordance with at least one embodiment;

FIG. 4C is a graph illustrating an association between the workers, in accordance with at least one embodiment;

FIG. 5A is a graph illustrating a method for updating the weights, in accordance with at least one embodiment; and

FIG. 5B is a graph illustrating an updated weights on the one or more edges, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITIONS

The following terms shall have, for the purposes of this application, the meanings set forth below.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external/internal group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “worker” refers to a workforce/worker(s) that may perform one or more tasks that generate data that contributes to a defined result. According to the present disclosure, the worker(s) includes, but is not limited to, a satellite center employee, a rural business process outsourcing (BPO) firm employee, a home-based employee, or an internet-based employee. Hereinafter, the terms “crowdworker”, “remote worker”, “sourced workforce”, and “crowd” may be used interchangeably. The worker may perform the crowdsourcing tasks using various types of devices, such as, but not limited to, a laptop, a mobile phone, a PDA, a tablet, a phablet, and the like.

A “crowdsourcing task” refers to a piece of work, an activity, an action, a job, an instruction, or an assignment to be performed. Tasks may necessitate the involvement of one or more workers. Examples of tasks may include, but are not limited to, image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image-analysis, directory compilation, or information search/retrieval.

A “remuneration” refers to a reward paid to the worker for completing a task posted on the crowdsourcing platform server. In an embodiment, examples of the reward may include, but are not limited to, a monetary compensation, lottery tickets, gift items, shopping vouchers, and discount coupons. In another embodiment, the reward may further correspond to strengthening of the relationship between the worker and the requestor. For example, the requestor may provide the worker with an access to more tasks so that the worker can gain more. In addition, through rewards, the crowdsourcing platform may improve a reputation score associated with the worker. In an embodiment, the worker with a higher reputation score may receive a higher reward. A person skilled in the art would understand that combination of any of the above-mentioned means of reward could be used and the task completion cost for the requestors may be inclusive of such rewards receivable by the corresponding workers.

A “graph” refers to a representation of one or more nodes that are connected with each other through one or more edges. In an embodiment, the one or more edges are representative of an association between the one or more nodes. In an embodiment, the one or more nodes in the graph may be representative of one or more workers.

A “metric” refers to a standard of measurement by which efficiency, performance, progress, or quality of a plan, process, or product can be assessed.

A “density” refers to a metric of a graph that is determined based at least on a count of the one or more edges in the graph and the maximum possible count of the one or more edges to connect the one or more nodes of the graph. In an embodiment, for a graph G=(N, E) that is comprised of a set of nodes (N) and a set of edges (E), where E⊂ N×N, the density for the graph is defined as:

$$Density = \frac{2 \vert E \vert}{\vert N \vert ( \vert N \vert - 1 )}$$

where,

|E|=the number of edges, and |N|=the number of nodes.

A “centrality” refers to a metric of a graph that corresponds to a count of the one or more edges associated with each of the one or more nodes in the graph. The degree centrality C_{D}(vᵢ) for each node is defined as the number of links/edges associated with a node. In an embodiment, for a network N=(V, E), the degree centrality C_{D}(N) for the network is calculated as follows:

$${C}_{D} ( N ) = \frac{{\sum }_{i = 1}^{\vert V \vert} ( {C}_{D} ( {v}^{*} ) - {C}_{D} ( {v}_{i} ) )}{( \vert V \vert - 1 ) ( \vert V \vert - 2 )}$$

where,

C_{D}(v*)=Maximum degree centrality in the network, and |V|=Total number of vertices.

A “core-to-periphery ratio” refers to a metric of a graph that corresponds to a ratio of a count of nodes with a degree greater than two and a count of nodes with a degree less than or equal to two, in the respective graph, in a recursive manner. The degree of a node may correspond to a count of the one or more edges associated with respective node in the graph. In an embodiment, in a graph, firstly remove all nodes with a degree less than or equal to two and all edges associated with these nodes. The process is repeated until all nodes left having a degree greater than 2. The nodes left belong to core, while all the nodes removed belong to periphery. Further, the core-to-periphery ratio may be computed as the number of core nodes divided by the number of periphery nodes.

“Interaction” refers to an association between the one or more workers, between the one or more crowdsourcing tasks, or between the workers and the crowdsourcing tasks.

“One or more strategies” refer to one or more recommendations provided to the workers. In an embodiment, the one or more recommendations to a first set of workers may include, but are not limited to, a recommendation for attempting a first set of crowdsourcing tasks, or for increasing interaction with a second set of workers.

A “first time instance” refers to a real time instance (i.e., a current time) in which analysis of data takes place for generating a graph. Based on the graph, one or more strategies may be generated and thereafter used to provide a set of recommendations to the one or more workers.

A “second time instance” refers to a time instance that precedes the first time instance. In an embodiment, the second time instance may have a very small difference from the first time instance (delta difference). In an embodiment, the first time instance may be decremented by a small value (a threshold time instance) one or more times to obtain one or more second time instances. Data at the one or more second time instances may be analyzed to update the graph.

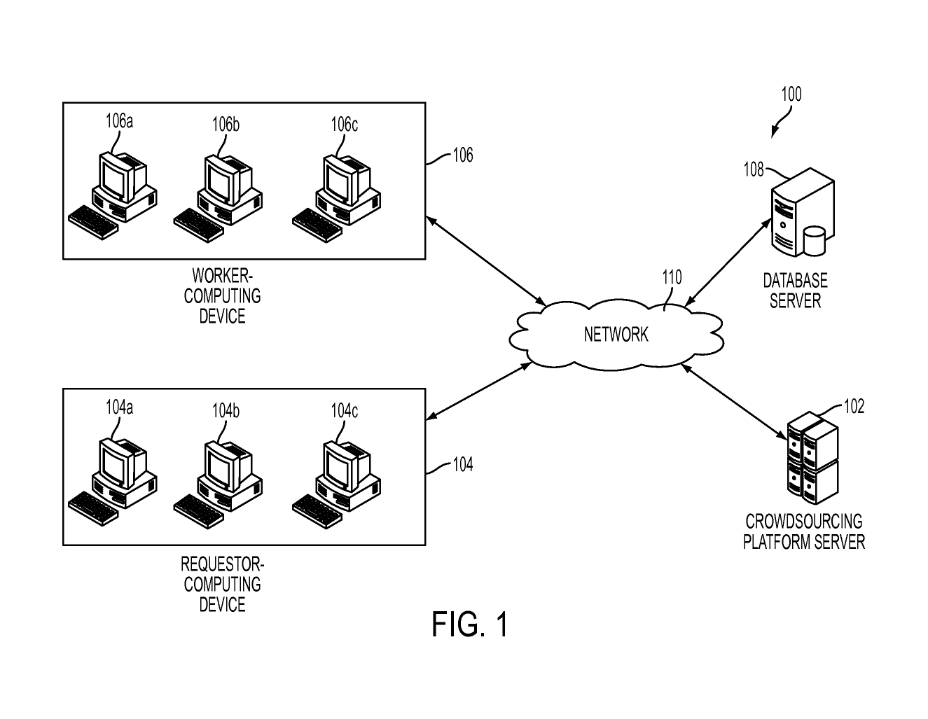

FIG. 1 is a block diagram of a system environment 100, in which various embodiments can be implemented. The system environment 100 includes a crowdsourcing platform server 102, one or more requestor-computing devices 104a, 104b, and 104c (hereinafter collectively referred to as requestor-computing device 104), one or more worker-computing devices 106a, 106b, and 106c (hereinafter collectively referred to as worker-computing device 106), a database server 108, and a network 110.

The crowdsourcing platform server 102 refers to a computing device that is configured to host one or more crowdsourcing platforms. The crowdsourcing platform server 102 may interact with the one or more requestor-computing devices, (hereinafter collectively referred to as requestor-computing device 104) over the network 110. The crowdsourcing platform server 102 may receive one or more crowdsourcing tasks from the requestor-computing device 104. In an embodiment, the crowdsourcing platform server 102 may allow access to, one or more workers operating on the one or more worker-computing devices (hereinafter collectively referred to as worker-computing device 106), for the one or more crowdsourcing tasks that are available on the crowdsourcing platform server 102. In an embodiment, the one or more workers may collaborate and interact to execute the one or more crowdsourcing tasks. In an embodiment, the one or more crowdsourcing tasks may be executed by a certain set of the one or more workers. In an embodiment, the crowdsourcing platform server 102 may collect information pertaining to the interactions of the one or more workers with the one or more crowdsourcing tasks. Further, the crowdsourcing platform server 102 may store such information in the database server 108. In an embodiment, such information may include details pertaining to, but not limited to, interaction among the one or more workers to perform a particular crowdsourcing task, remuneration offered by the requestor associated with one or more tasks, and type of tasks selected by the one or more workers.

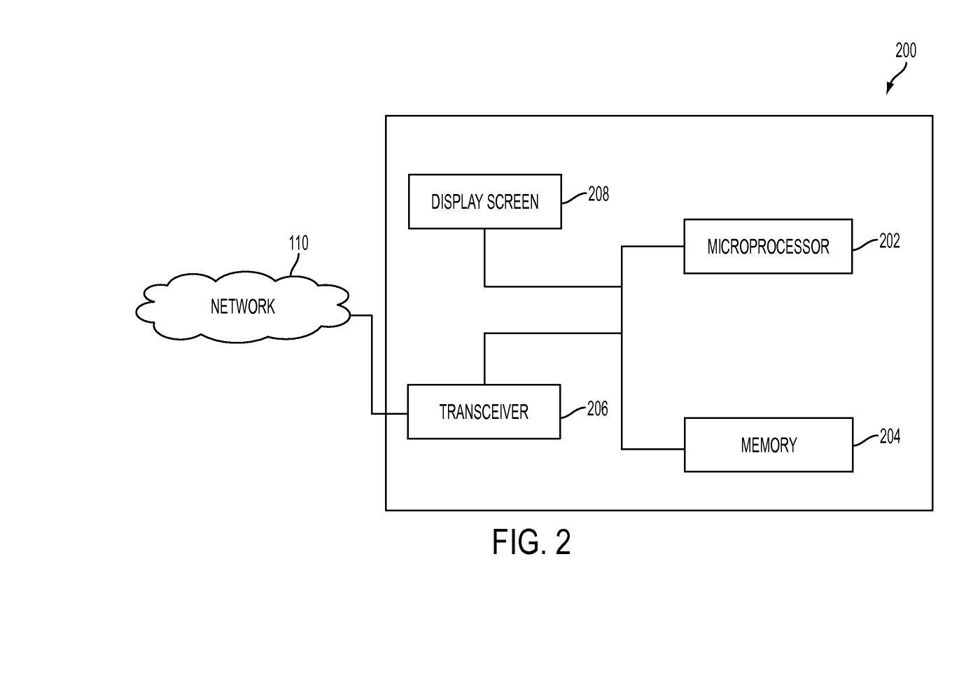

The crowdsourcing platform server 102 may collect real time data pertaining to the interactions. At a first time instance, the crowdsourcing platform server 102 may generate one or more first graphs representative of at least one of an association between the one or more workers, between the one or more crowdsourcing tasks, or between the one or more workers and the one or more crowdsourcing tasks. Further, the crowdsourcing platform server 102 may determine values of one or more metrics associated with the one or more first graphs. Thereafter, the crowdsourcing platform server 102 may compare the determined values of the one or more metrics with threshold values of the one or more metrics. In an embodiment, the crowdsourcing platform server 102 may generate one or more second graphs indicative of interactions between the one or more workers and the one or more tasks at a second time instance. In an embodiment, the second time instance precedes the first time instance and the interactions at the second time instance may correspond to historical data or historical interactions between the one or more workers and the one or more crowdsourcing tasks. In an embodiment, the crowdsourcing platform server 102 may determine one or more strategies based on the one or more second graphs. The one or more strategies may include one or more recommendations. The crowdsourcing platform server 102 may provide the one or more recommendations to a first set of workers, for attempting a first set of crowdsourcing tasks from the one or more crowdsourcing tasks, or for increasing interaction with a second set of workers. The crowdsourcing platform server 102 has been described later in conjunction with FIG. 2.

The crowdsourcing platform server 102 may be realized through an application server such as, but not limited to, a Java application server, a .NET framework, and a Base4 application server.

The requestor-computing device 104 refers to a computing device that may be utilized by one or more requestors to post the one or more crowdsourcing tasks on the crowdsourcing platform server 102 over the network 110. In an embodiment, the requestor-computing device 104 may access submitted one or more responses associated with the one or more crowdsourcing tasks from the crowdsourcing platform server 102. Further, the connections made in a process of communication with the crowdsourcing platform server 102 can either be wired or wireless. The requestor-computing device 104 may include different types of devices, such as, but not limited to, desktop computers, laptops, netbooks, PDAs, smartphones, tablets, and so on.

The worker-computing device 106 refers to a computing device that may be utilized by one or more workers, for selecting and executing the one or more crowdsourcing tasks posted by the one or more requestors on the crowdsourcing platform server 102. In one embodiment, the one or more workers collaborate and interact to work together on the one or more crowdsourcing tasks. The worker-computing device 106 may include, but is not limited to, a smartphone, a laptop, a personal digital assistant (PDA), a tablet, a netbook, a desktop computer, and so on.

The database server 108 stores the information pertaining to the interactions among the one or more crowdsourcing tasks and the one or more workers, at one or more time instances preceding the first time instance. The information may be referred as historical data and may be utilized by the crowdsourcing platform server 102 to analyze the performance of a crowdsourcing system associated with the system environment 100. In an embodiment, the database server 108 may store a list of one or more metrics associated with the one or more graphs. Further, the database server 108 may store the threshold range of values corresponding to the one or more metrics. In an embodiment, the database server 108 may store the determined one or more strategies by the crowdsourcing platform server 102. The database server 108 may be implemented using technologies including, but not limited to, Oracle®, IBM DB2®, Microsoft SQL Server®, Microsoft Access®, PostgreSQL®, MySQL® and SQLite®, and the like.

The network 110 corresponds to a medium through which content and messages flow between various devices of the system environment 100 (e.g., the crowdsourcing platform server 102, the requestor-computing device 104, the worker-computing device 106, and the database server 108). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as the Transmission Control Protocol and Internet Protocol (TCP/IP), User Datagram Protocol (UDP), and 2G, 3G, or 4G communication protocols.

FIG. 2 is a block diagram that illustrates a computing device 200 for determining the one or more strategies for crowdsourcing, in accordance with at least one embodiment. For the purpose of the ongoing disclosure, the computing device 200 has been considered as the crowdsourcing platform server 102. However, the scope of the disclosure should not be limited to the computing device 200 as the crowdsourcing platform server 102. The computing device 200 can also be realized as the requestor-computing device 104, or the worker-computing device 106.

The computing device 200 includes a microprocessor 202, a memory 204, a transceiver 206, and a display screen 208. The microprocessor 202 is coupled to the memory 204, the transceiver 206, and the display screen 208. The transceiver 206 may connect to the network 110.

The microprocessor 202 includes suitable logic, circuitry, and/or interfaces that are operable to execute one or more instructions stored in the memory 204 to perform threshold operations. The one or more microprocessors 202 may be implemented using one or more processor technologies known in the art. Examples of the microprocessor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the one or more microprocessors 202 to perform specific operations. It is apparent to a person with ordinary skills in the art that the one or more instructions stored in the memory 204 enable the hardware of the computing device 200 to perform the threshold operations.

The transceiver 206 transmits and receives messages and data to/from various components of the system environment 100 (e.g., the requestor-computing device 104, the worker-computing device 106, and the database server 108) over the network 110. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

The display screen 208 may comprise suitable logic, circuitry, interfaces, and/or code that may be operable to render a user interface. In an embodiment, the display screen may be utilized to display one or more strategies to a user though a user interface. In an embodiment, the display screen 208 may be realized through several known technologies, such as, Cathode Ray Tube (CRT) based display, Liquid Crystal Display (LCD), Light Emitting Diode (LED) based display, Organic LED display technology, and Retina display technology. In an alternate embodiment, the display screen 208 may be capable of receiving input. In such a scenario, the display screen 208 may be a touch screen that enables the user to provide input. In an embodiment, the touch screen may correspond to at least one of a resistive touch screen, capacitive touch screen, or a thermal touch screen. In an embodiment, the display screen 208 may receive input through a virtual keypad, a stylus, a gesture, and/or touch based input.

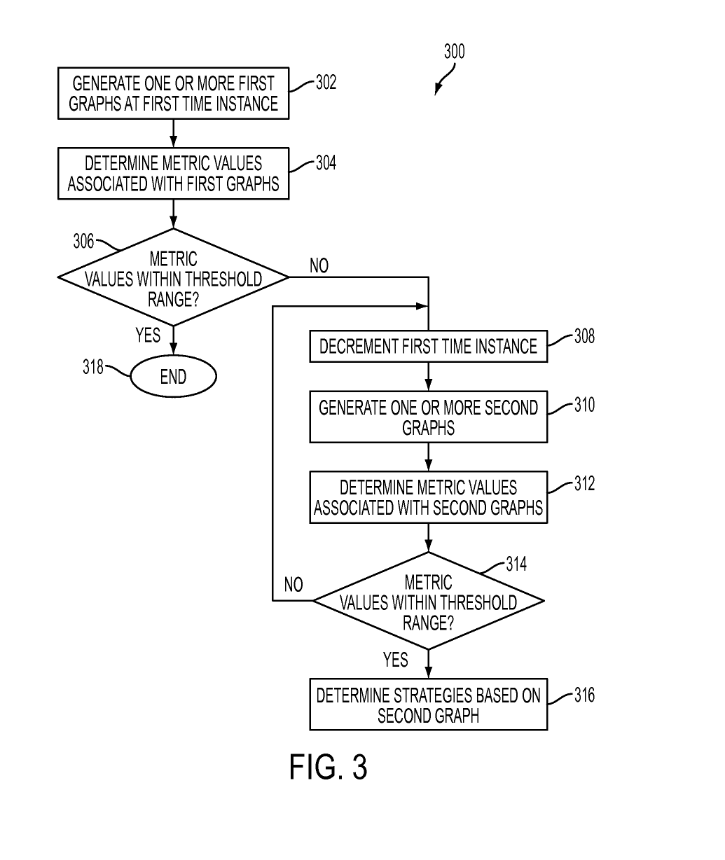

FIG. 3 illustrates a flowchart 300 for determining the one or more strategies of crowdsourcing one or more tasks, in accordance with at least one embodiment. The flowchart 300 has been described in conjunction with FIG. 1 and FIG. 2.

At step 302, the one or more first graphs at the first time instance are generated. In an embodiment, the microprocessor 202 may generate the one or more first graphs at the first time instance. In an embodiment, the first time instance may relate to a real-time (current time instance). In an embodiment, prior to generating the one or more first graphs, the microprocessor 202 may retrieve real time data pertaining to the interaction among the one or more workers and the one or more crowdsourcing tasks. For example, in an embodiment, the workers (i.e., outreach/remote workers and research workers) are involved in a process of collecting data from a project for employers to convert paper-based payment to electronic-based payment. The research workers may determine contact information based on paper checks. Thereafter, the outreach/remote workers call employers to persuade them to convert from paper-based payment to electronic-based payment. During the process, multiple workers may work on the same crowdsourcing task from the one or more crowdsourcing tasks.

Based on the real time data pertaining to the interaction among the one or more workers and the one or more crowdsourcing tasks, the microprocessor 202 may generate a graph. The graph may include one or more nodes and the one or more edges. In an embodiment, the one or more nodes may correspond to one or more workers and the one or more crowdsourcing tasks. Further, an edge in the graph may represent an association between the one or more workers and the one or more crowdsourcing tasks. The graph may represent an association between the one or more workers and the one or more crowdsourcing tasks. In an embodiment, the real time data corresponds to the first time instance.

### Worker-Task Graph

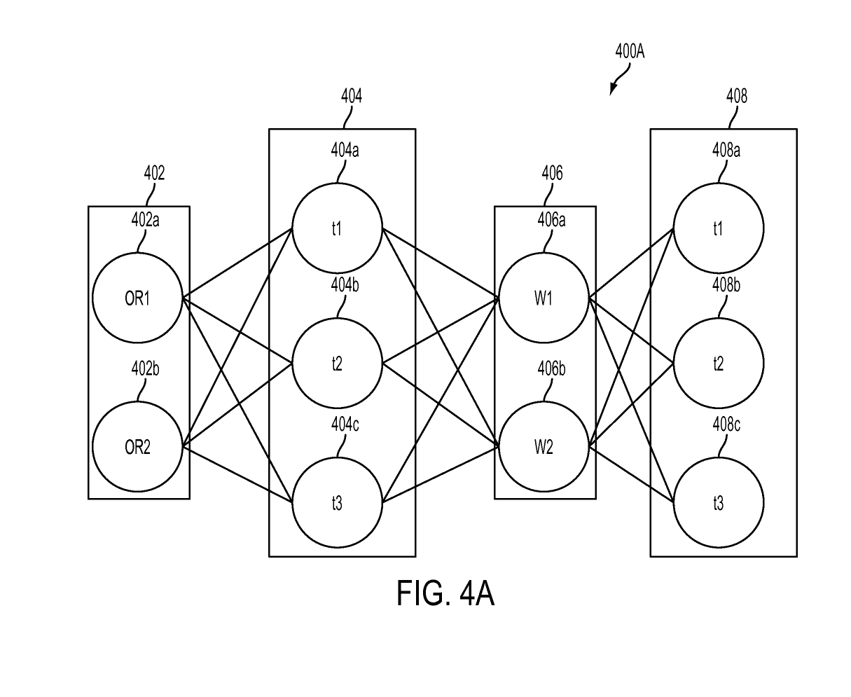

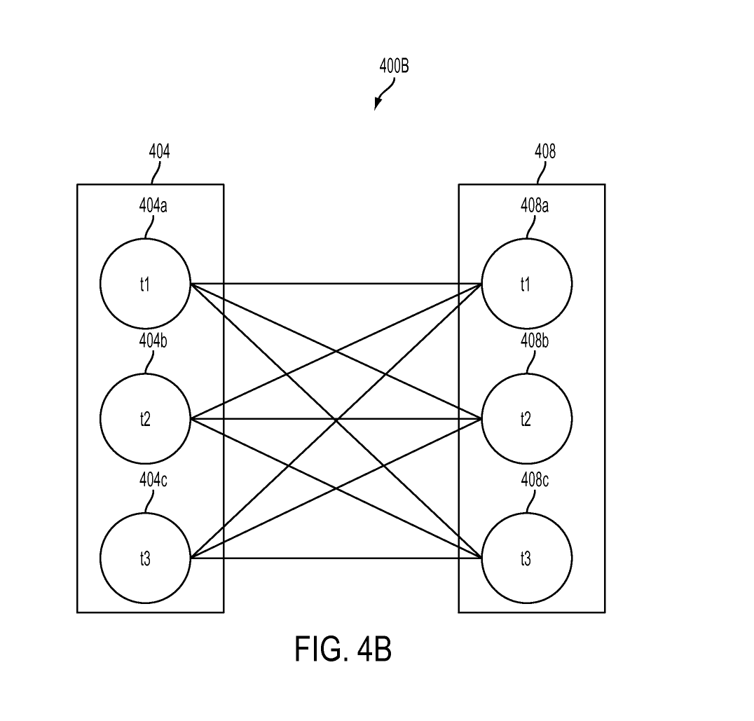

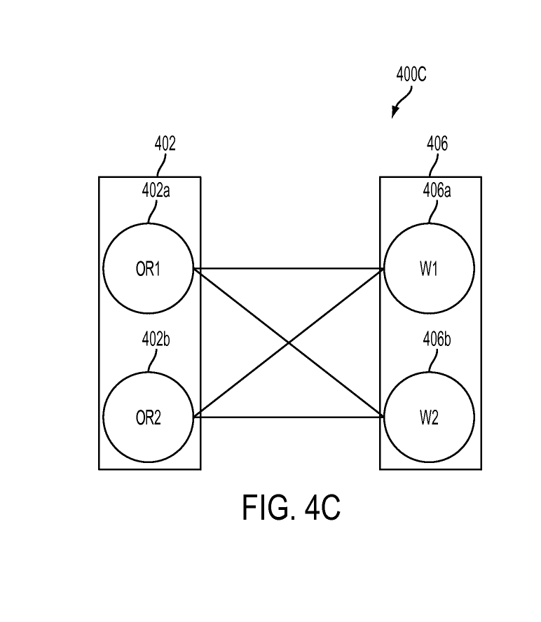

In an embodiment, the association between the one or more workers and the one or more crowdsourcing tasks refers to the interaction among the one or more workers to execute the one or more tasks. In an embodiment, the multiple workers may work on the same crowdsourcing task and a single worker may work on multiple crowdsourcing tasks. In such a scenario, the one or more first graphs may depict an association of each of the one or more workers with each of the one or more crowdsourcing tasks depending on which worker works on which crowdsourcing task. For example, in the one or more first graphs, the first/second set of nodes depicts the first/second set of workers from the one or more workers and the third set of nodes depicts the one or more crowdsourcing tasks. The worker-task graph has been described later in conjunction with FIG. 4A.

### Task-Task Graph

In an embodiment, the microprocessor 202 may omit the workers from the worker-task graph (discussed above) to determine the association between the one or more crowdsourcing tasks. The association between the one or more crowdsourcing tasks may be determined based on one or more parameters. The one or more parameters may include, but are not limited to, open tasks, in progress tasks, and processed tasks. In an embodiment, the database server 108 may maintain a mapping table that illustrates status of the one or more crowdsourcing tasks. An example of the mapping table has been illustrated in the following table:

TABLE 1
Task Status Type

| Task Status | |
|---|---|
| Number | Task Status Category |
| 1 | Open |
| 2 | In Progress |
| 3 | Under Research |
| 4 | Not This Time |
| 5 | Transferred To Conversion |
| 6 | Payroll |
| 7 | Processed |
| 8 | Bad Check Image |
| 9 | In Conversion |

It can be observed from the Table 1 that the database server 108 may contain nine types of statuses of each of the one or more crowdsourcing tasks. Further, the microprocessor 202 may categorize the statuses into three groups. For example, the task having task status numbers such as, “5”, “7”, or “9”, may be considered as “good”. Similarly, the task having task status numbers such as, “4”, “6”, or “8”, may be considered as “neutral”, while the task having the task status numbers such as, “1”, “2”, or “3”, may be considered as “bad”. Based on the generated task-task graph, the microprocessor 202 may determine the one or more tasks that have been processed. For example, in an embodiment, the one or more tasks that have been processed may be present in the center of the graph such that the one or more tasks may have more edges than other tasks. In an embodiment, the one or more crowdsourcing tasks may be depicted by the third set of nodes in the one or more first graphs. The task-task graph has been further described later in conjunction with FIG. 4B.

### Worker-Worker Graph

In an embodiment, the microprocessor 202 may omit the tasks from the worker-task graph, as described above. After omitting the tasks from the worker-task graph, the microprocessor 202 may generate the worker-worker graph that depicts the association between the one or more workers. The association between the one or more workers may correspond to the collaboration and the interaction among the one or more workers. For example, in the one or more first graphs, a first set of workers from the one or more workers may be depicted by the first set of nodes and the second set of workers from the one or more workers may be depicted by the second set of nodes. The worker-worker graph has been described later in conjunction with the FIG. 4C.

It would be apparent to a person skilled in the art that any of the above mentioned graphs may be utilized to represent the association between the one or more workers, between the one or more crowdsourcing tasks, or between the one or more workers and the one or more crowdsourcing tasks.

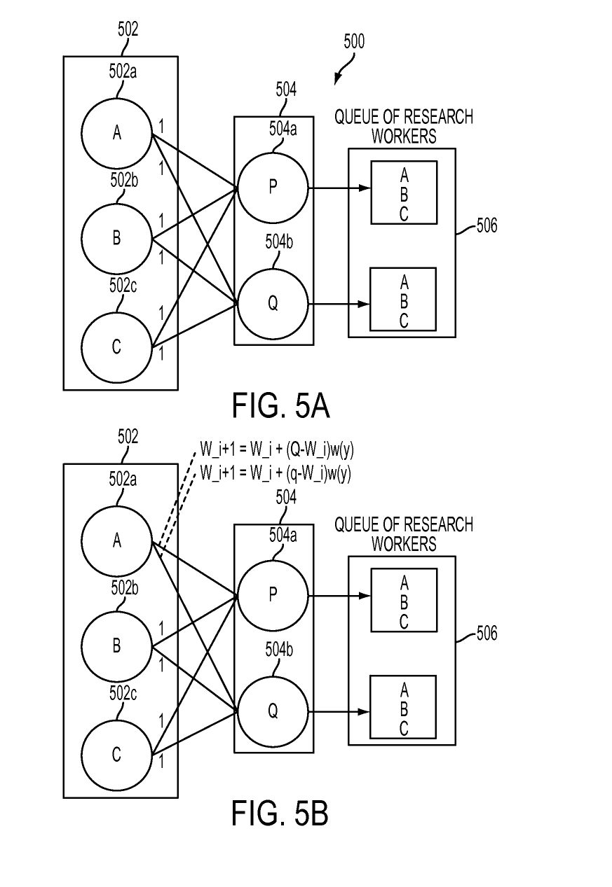

In an embodiment, the microprocessor 202 may determine a weight associated with each of the one or more edges. The weight associated with each of the one or more edges may correspond to a degree of the association between the one or more workers, between the one or more crowdsourcing tasks, or between the one or more workers and the one or more crowdsourcing tasks. For example, in an embodiment, if there are three research workers (A, B, C) and two outreach workers (P, Q). The one or more crowdsourcing tasks may be performed sequentially (for example, a task of research work may be followed by a respective task of outreach work). In an embodiment, the microprocessor 202 may assign one or more edges between the research workers and the outreach workers with a weight equal to one (i.e., default weight). Therefore, the one or more edges may represent the collaboration and the weight on the one or more edges may represent the strength of the collaboration. Hence, it is evident that more the weight assigned to the edges, stronger is the collaboration between the outreach workers and the research workers. In an embodiment, the microprocessor 202 may further update the weights based at least on a performance of the one or more workers in performing the one or more crowdsourcing tasks. The updating of weights has been described later in conjunction with FIG. 5.

At step 304, the one or more metric values associated with the one or more first graphs are determined. In an embodiment, the microprocessor 202 may determine values of the one or more metrics associated with each of the one or more first graphs. The one or more metrics associated with each of the one or more first graphs may include, but are not limited to, a density, a centrality, a core-to-periphery ratio, a clustering coefficient, and a path length associated with the one or more first graphs.

Density Associated with One or More First Graphs

In an embodiment, the microprocessor 202 may determine the density associated with one or more first graphs based at least on a count of the one or more edges in the one or more first graphs and the maximum possible count of the one or more edges to connect the one or more nodes of the graph. As discussed above, the set of nodes may correspond to the one or more workers, or the one or more tasks in the one or more first graphs. For example, in an embodiment, the one or more first graphs may include a set of nodes (N) and a set of edges (E). In an embodiment, the microprocessor 202 may utilize following equation to determine the density:

$$Density = \frac{2 \vert E \vert}{\vert N \vert ( \vert N \vert - 1 )} \qquad ( 1 )$$

where,

|E|=Total Number of edges in the graph,

|N|=Total Number of nodes in the graph.

Centrality Associated with One or More First Graphs

In an embodiment, the microprocessor 202 may determine the centrality associated with the one or more first graphs based at least on a degree centrality associated with each node in the first/second/third set of nodes and a count of nodes in the first/second/third set of nodes. The degree centrality associated with each node in the first/second/third set of nodes may correspond to a count of the one or more edges associated with respective node. In an embodiment, the degree centrality C_{D}(vᵢ) for each node may be determined by using the below equation:

$${C}_{D} ( N ) = \frac{{\sum }_{i = 1}^{\vert V \vert} ( {C}_{D} ( {v}^{*} ) - {C}_{D} ( {v}_{i} ) )}{( \vert V \vert - 1 ) ( \vert V \vert - 2 )} \qquad ( 2 )$$

where,

N=Notation of the network,

C_{D}(N)=Degree Centrality for the network,

C_{D}(v*)=Maximum degree centrality in the graph,

|V|=Total number of vertices.

Core-to-Periphery Ratio Associated with One or More First Graphs

In an embodiment, the microprocessor 202 may determine the core-to periphery ratio of the one or more first graphs based at least on a ratio of a count of nodes with a degree greater or equal to two and a count of nodes with a degree less than two, in the respective graph, in a recursive manner. The degree may correspond to a count of the one or more edges associated with the respective graph. For example, in a socio-technical graph G1, a graph G2 is generated after removing all nodes with degree centralities less than or equal to 2 in the graph G1. The same process is applied to the graph G2. This process is continued until all nodes with degree centralities less than or equal to 2 are removed. The nodes left are core members, while the nodes removed are periphery members. In an embodiment, the core-to-periphery ratio may be determined based on a ratio of the number of core members to the number of periphery members. In an embodiment, the microprocessor 202 may determine the core-to-periphery ratio by utilizing the following equation:

$$Core \text{-} to \text{-} periphery Ratio = \frac{Number of core members}{Number of periphery members} \qquad ( 3 )$$

where,

Core Members=Number of nodes Left,

Periphery Members=Number of nodes removed.

Clustering Coefficient Associated with One or More First Graphs

In an embodiment, the microprocessor 202 may determine the clustering coefficient associated with the one or more graphs based at least on the number of edges among all the neighbors of the vertex, i and total degree of the vertex, i. In an embodiment, the microprocessor 202 may utilize following below equation to determine the clustering coefficient:

$${C}_{i} = \frac{\vert \{ {e}_{jk} \} \vert}{{k}_{i} ( {k}_{i} - 1 )} : {v}_{j} , {v}_{k} ∈ {N}_{i} , {e}_{jk} ∈ E \qquad ( 4 )$$

where,

Cᵢ=Clustering Coefficient of node i,

ki=Total degree of the vertex i,

|{eⱼₖ}|=Number of edges among all the neighbors of vertex i.

Path Length Associated with One or More First Graphs

In an embodiment, the microprocessor 202 may determine the average path length associated with the one or more graphs. The path length between any two nodes is the number of edges of the shortest path. The average path length of the graph is the average of path length between all pairs of nodes.

A person having ordinary skill in the art would appreciate that the scope of the disclosure is not limited to the above disclosed one or more metrics. In an embodiment, the microprocessor 202 may employ other metrics as well, without departing from the scope of the disclosure.

At step 306, it is determined whether the one or more metric values are within the threshold range. In an embodiment, the microprocessor 202 may determine this based on a comparison. The comparison may be performed between the determined values of the one or more metrics and the threshold range of values corresponding to the one or more metrics. In an embodiment, the microprocessor 202 may retrieve a list of the one or more metrics and the threshold range of values corresponding to the one or more metrics from the database server 108. The threshold range of values corresponding to the one or more metrics may correspond to a range of values of the one or more metrics for which the crowdsourcing system may be efficient. In an embodiment, based on the comparison, the microprocessor 202 may determine if the crowdsourcing system is efficient at the first time instance. In case the microprocessor 202 determines that the crowdsourcing system is efficient, the method ends (i.e. the step 318 is performed), else the step 308 is performed.

At step 308, the first time instance is decremented. In an embodiment, the microprocessor 202 may decrement the first time instance by a threshold time instance to the second time instance for further analysis. The switch to the second time instance that precedes the first time instance facilitates an analysis of the collaboration and the interaction among the one or more workers at previous time instances. Further, the microprocessor 202 may extract historical data pertaining to the historical interactions among the one or more workers and the one or more tasks.

At step 310, the one or more second graphs are generated. In an embodiment, the microprocessor 202 may generate the one or more second graphs for historical interactions at the second time instance. The one or more second graphs may represent at least one of the previous association between the one or more workers, and the one or more crowdsourcing tasks. In an embodiment, the association between the one or more workers and the one or more crowdsourcing tasks may correspond to the interaction among the one or more workers to execute the one or more tasks, as described above in the worker-task graph (i.e., in the step 302).

In an embodiment, the microprocessor 202 may omit the workers from the worker-task graph to generate the task-task graph. The association between the one or more crowdsourcing tasks may be determined based on the one or more parameters, as discussed in the step 302. In another embodiment, the microprocessor 202 may omit the tasks from the worker-task graph to generate the worker-worker graph. The association between the one or more workers refers to the collaboration and the interaction among the one or more workers, as disclosed above.

At step 312, the one or more metric values associated with the one or more second graphs are determined. In an embodiment, the microprocessor 202 may determine values of the one or more metrics associated with the one or more second graphs. The one or more metrics may include, but not limited to, the density, the centrality, the core-to-periphery ratio, the clustering coefficient, and the path length associated with the one or more second graphs, as discussed above in the step 304.

At step 314, it is determined whether the one or more metric values are within the threshold range. In an embodiment, the microprocessor 202 may determine this based on a comparison. The comparison may be performed between the determined values of the one or more metrics (associated with the one or more second graphs) with the threshold range of values corresponding to the one or more metrics. In an embodiment, the microprocessor 202 may compare the determined values of the one or more metrics with the threshold values of the one or more metrics, to identify if the determined values of each of the one or more metrics is within the threshold range of values of the respective one or more metrics, for the one or more second graphs generated at the step 310. In such type of scenario, if the values of each of the one or more metrics is within the threshold range of values of the respective one or more metrics, the crowdsourcing system is identified as efficient, then the step 316 is performed, else the step 308 and the successive steps may be performed each time for the next preceding time instances. Typically, the crowdsourcing system may be efficient when the density may be low, the centrality may be high, and the core-to-periphery ratio may be high as per the threshold range of values of the one or more metrics.

In an embodiment, if the microprocessor 202 determines that the crowdsourcing system is not efficient, the first time instance may be again decremented by the threshold time instance to obtain another second time instance, as discussed above in the step 308. In such scenarios, the step 310 to the step 314 may be performed for a set of second time instances until the time instance when the values of each of the one or more metrics is within the threshold range of values of the respective one or more metrics and the crowdsourcing system is identified as efficient.

At step 316, the one or more strategies are determined. In an embodiment, the microprocessor 202 may determine the one or more strategies based on the one or more second graphs and the determined values of the one or more metrics for which the crowdsourcing system may be identified as efficient for the second time instance. The one or more strategies may include, but are not limited to, a recommendation to the first set of workers, from the one or more workers, for attempting a first set of crowdsourcing tasks, from the one or more crowdsourcing tasks. In another embodiment, the strategy may be a recommendation to the first set of workers for increasing interaction and collaboration with the second set of workers. The microprocessor 202 may implement the recommendations in such a way that the behavior and association with the one or more second workers and/or the one or more crowdsourcing tasks, and selection of crowdsourcing tasks of/by the first set of workers results in change in the values of the one or more metrics at the first instance so that these values are similar to the values of the one or more metrics determined at the second time instance. For example, in an embodiment, the microprocessor 202 may employ one or more workers to focus on a single state, while others to handle two or more states. In such type of scenario, the cross-state issues may be handled. In an embodiment, the microprocessor 202 may recommend the first set of workers to work with the second set of workers based on the updated weights. In an embodiment, the microprocessor 202 may display the one or more strategies to a user through a user interface.

In an embodiment, after recommending the first set of workers to increase an interaction with the second set of workers, the microprocessor 202 may create a communication channel between the first set of workers and the second set of workers. Examples of the communication channel may include, but are not limited to, a chat window, a messenger window, an email based communication channel, or a social media based communication channel, and so on. In an embodiment, the communication channel may be created based on a consent from the first set of workers and the second set of workers. For example, the first set of workers may be prompted with an option for creation of such communication channel. If the first set of workers agree, the second set of workers may then be prompted with a similar option. Based on an assent from both the first set of workers and the second set of workers, the microprocessor 202 may create the communication channel.

Further, a person skilled in the art would appreciate that the first and the one or more second graphs may be displayed to the first and the second set of workers, without departing from the scope of the disclosure.

It will be apparent to a person skilled in the art that the multiple strategies may be determined and recommended such that the crowdsourcing system behaves as an efficient system.

FIG. 4A is a graph 400A illustrating an association between the one or more workers and the one or more crowdsourcing tasks, in accordance with at least one embodiment.

As discussed above, the microprocessor 202 may generate the first graph (depicted as 400A). In an embodiment, the first graph 400A may depict an association of each of the one or more workers with each of the one or more crowdsourcing tasks depending on which worker works on which crowdsourcing task (as disclosed above). As depicted in the FIG. 4A, the first graph 400A may include the first set of nodes (depicted by 402), the second set of nodes (depicted by 406), and the third set of nodes (depicted by 404 and 408). The first set of nodes (i.e., 402) and the second set of nodes (i.e., 406) may correspond to the first set of workers (i.e., outreach workers) and the second set of workers (i.e., research workers), respectively. Further, the third set of nodes (i.e., 404 and 408) may correspond to the one or more crowdsourcing tasks. For example, the one or more crowdsourcing tasks (i.e., 404 and 408) relate to processing checks from 6 states including LA, NJ, OH, TX, FL, and MD. The total number of the outreach workers 402 and the research workers 406 may be 7 and 17, respectively. In such a scenario, if the microprocessor 202 assigns the 17 research workers (depicted by 406) to 6 states, then each research worker deals only with the one or more crowdsourcing tasks (i.e., 404 and 408) from a single state. Further, the microprocessor 202 may assign any 5 outreach workers (depicted by 402) to deal with the one or more crowdsourcing tasks (i.e., 404 and 408) from a randomly selected single state, while the other 2 outreach workers (depicted by 402) may be assigned to deal with the one or more crowdsourcing tasks (i.e., 404 and 408) from two or more states.

It will be apparent to a person skilled in the art that the graph 400A may be centered around the two outreach workers who may be able to deal with the one or more crowdsourcing tasks from more than two states. From the first graph 400A, it is evident that the multiple workers may work on the same crowdsourcing task. The microprocessor 202 may employ a strategy from the one or more strategies to recommend some workers to focus on a single state, while recommending others to deal with two or more states so that cross-state issues may be handled.

FIG. 4B is a graph 400B illustrating an association between the one or more crowdsourcing tasks, in accordance with at least one embodiment.

As discussed above in the FIG. 4A, the microprocessor 202 generates the first graph 400A. In an embodiment, if the microprocessor 202 omits the first set of nodes (i.e., 402) and the second set of nodes (i.e., 406) from the graph 400A, the graph 400B may be generated. The graph 400B depicts the association between the one or more crowdsourcing tasks (i.e., 404 and 408). The association between the one or more crowdsourcing tasks (i.e., 404 and 408) may be determined based on one or more parameters. The one or more parameters may correspond to open tasks, in progress tasks, and processed tasks, as discussed in the step 302.

FIG. 4C is a graph 400C illustrating an association between the one or more workers, in accordance with at least one embodiment.

As discussed above in the FIG. 4A, the microprocessor 202 generates the graph 400A. In an embodiment, if the microprocessor 202 omits the third set of nodes (i.e., 404 and 408) from the graph 400A, the graph 400C may be generated. The graph 400C depicts the association between the first set of nodes (i.e., 402) and the second set of nodes (i.e., 406). The first set of nodes 402 and the second set of nodes 406 may correspond to the first set of workers (i.e., outreach workers) and the second set of workers (i.e., research workers), respectively, as discussed above. Based on the association between the first set of nodes 402 and the second set of nodes 406, the microprocessor 202 may determine the one or more metric values associated with the graph 400C. For example, in an embodiment, the microprocessor 202 may determine values of the density, the centrality, and the core-to-periphery ratio as 0.36, 0.56, and 22.0, respectively. Further, based on the comparison between the determined values of the density, the centrality, and the core-to-periphery ratio with the threshold range of values of the density, the centrality, and the core-to-periphery ratio, the one or more second graphs are generated. Thereafter, the one or more strategies may be determined and further implemented, based on the collaborations, interactions, and associations among the outreach workers, the research workers, and the one or more crowdsourcing tasks, such that the crowdsourcing system may be efficient.

FIG. 5A is a graph illustrating a method for updating the weights, in accordance with at least one embodiment.

As shown in the FIG. 5A, there are three research workers A, B, and C (depicted by 502) and two outreach workers P, and Q (depicted by 504). The research workers 502 may further be displayed on a screen (depicted by 506). The screen 506 may include order of research workers 502 in a queue. As shown in the FIG. 5A, the outreach workers 504 have one or more edges from the research workers 502 with weights equal to one. Since, the research workers 502 may be in a random order for the outreach worker ‘P’ 504a, therefore the order of research workers 502 in the queue displayed on the screen 506 may be in a random order. For example, in an embodiment, a task is successfully executed between the research worker 502a and the outreach worker 504a. Further, the task may have “y” remuneration. In an embodiment, the microprocessor 202 may assign maximum ‘Q’ weights to a direct connection and maximum ‘q’ weights to an indirect connection. Therefore, the microprocessor 202 may observe that the direct connection may be eligible for Q as maximum and the indirect connection may be eligible for q (<=Q) as maximum. Based on the successful execution of the task, the microprocessor 202 may update the weights corresponding to the direct/indirect connection. The microprocessor 202 may utilize the equation 5 and equation 6 to update the weights corresponding to the direct connections and indirect connections, respectively:

$$\begin{matrix}{W}_{i + 1} = {W}_{i} + ( Q - {W}_{i} ) * w ( y ) & ( 5 ) \\ {W}_{i + 1} = {W}_{i} + ( q - {W}_{i} ) * w ( y ) & ( 6 ) \\ w ( y ) = \frac{y - min\_remuneration}{max\_remuneration \_remuneration} & ( 7 )\end{matrix}$$

where,

Wᵢ₊₁=Weights at the next time,

Wᵢ=Weights at the current time,

$$\frac{y - min\_remuneration}{max\_remuneration \_remuneration} = Value lies between one and zero .$$

FIG. 5B is a graph illustrating updated weights on the one or more edges, in accordance with at least one embodiment.

As shown in the FIG. 5B, it can be observed that the one or more edges to the research worker 502a may have more weights than any other edges. The screen 506 may display the research worker 502a on the top of the queue. On the other hand, the screen 506 may display the research worker ‘B’ 502b and the research worker ‘C’ 502c in random.

In an embodiment, the microprocessor 202 may change size of nodes based on number of the one or more crowdsourcing tasks. In addition, the microprocessor 202 may vary thickness of the one or more edges based on the weights associated with the one or more edges. To make the crowdsourcing system more efficient and effective, the microprocessor 202 may assign the one or more crowdsourcing tasks within the specific area (e.g., industrial area, etc.) to the outreach workers and the research workers. In an embodiment, the microprocessor 202 may update the weights based on ratings provided by the first set of workers to the second set of workers. For example, in an embodiment, the microprocessor 202 may update the weights associated with each of the one or more edges between the research workers and the outreach workers based on feedback (i.e., rating between them).

The disclosed embodiments encompass numerous advantages. Typically, for evaluating the performance of the crowdsourcing system, statistic metrics at an aggregate level such as mean completion time and mean accuracy are analyzed. In such scenarios, this type of information is insufficient to determine the real cause to improve the performance of the crowdsourcing system. Through various embodiments of the methods and systems for determining strategies in crowdsourcing, it is disclosed that the performance of the crowdsourcing system may be evaluated based on a set of metrics corresponding to a set of graphs associated with the collaboration and the interaction between the workers, between the crowdsourcing tasks, or between the workers and the crowdsourcing tasks. The graph analysis may include both static snapshots and dynamic evolution of the performance of the crowdsourcing system from various aspects over time, for example, worker-worker relation, worker-task relation, task-task relation. Based on the graphical analysis, a set of strategies may be determined so that the efficiency of the crowdsourcing system may be improved. One strategy may be a recommendation to the workers, for attempting a set of crowdsourcing tasks based on one of the parameters such as higher remuneration. Another strategy may be a recommendation to the workers, for increasing interaction with other workers. These scenarios, once implemented, may increase the correlation and the interaction between the workers, improving the efficiency of the crowdsourcing system. Moreover, the behavior of the workers may be analyzed based on which the crowdsourcing tasks may be recommended to the workers for future.

In certain embodiments, the weight assignment is also disclosed. The concept of assigning weights to the collaborations between workers may serve as a parameter of promoting certain workers based on their collaboration. More weights may be given to a successful collaboration, which implies that the associated worker has been doing a great work. Thus, the worker may be promoted. Further, based on the increase in the remuneration, the weight associated with the worker also increases. Therefore, the weighting method encourages workers to choose tasks with high remuneration and to put their best effort in the tasks.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for formulating a policy for crowdsourcing of tasks have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for determining one or more strategies in crowdsourcing, said method comprising:
generating, by one or more microprocessors, one or more first graphs representative of at least one of an association between one or more workers, between one or more crowdsourcing tasks, or between said one or more workers and said one or more crowdsourcing tasks, at a first time instance;
determining, by said one or more microprocessors, values of one or more metrics associated with said one or more first graphs;
comparing, by said one or more microprocessors, said determined values of said one or more metrics and one or more threshold values of said one or more metrics;
generating, by said one or more microprocessors, one or more second graphs based on said comparison, wherein said one or more second graphs are representative of at least one of said association between said one or more workers, between said one or more crowdsourcing tasks, or between said one or more workers and said one or more crowdsourcing tasks, at a second time instance, wherein said second time instance precedes said first time instance;
determining, by said one or more microprocessors, said one or more strategies based on said one or more second graphs, wherein said one or more strategies comprise at least one of:
a recommendation to a first set of workers, from said one or more workers, for attempting a first set of crowdsourcing tasks, from said one or more crowdsourcing tasks, or
a recommendation to said first set of workers for increasing interaction with a second set of workers; and
displaying, by a display screen, said one or more strategies to a user through a user interface.

2. The method of claim 1, wherein said first set of workers and said second set of workers work on different stages of said one or more crowdsourcing tasks.

3. The method of claim 1, wherein said one or more metrics comprise at least one of a density of one or more first/second graphs, a centrality of said one or more first/second graphs, a core-to-periphery ratio of said one or more first/second graphs, a clustering coefficient associated with said one or more first/second graphs, or a path length associated said one or more first/second graphs.

4. The method of claim 1, wherein said one or more first graphs and said one or more second graphs comprises a first set of nodes depicting said first set of workers, a second set of nodes depicting said second set of workers, and a third set of nodes depicting said one or more crowdsourcing tasks.

5. The method of claim 4, wherein at least one of said first set of nodes, said second set of nodes, and said third set of nodes are interconnected by one or more edges depicting said association.

6. The method of claim 5 further comprising determining, by said one or more microprocessors, said density of said one or more first/second graphs based on a ratio of a count of said one or more edges in respective graph and a maximum possible count of said one or more edges to connect respective set of nodes.

7. The method of claim 5 further comprising determining, by said one or more microprocessors, said centrality of said one or more first/second graphs based at least on a degree centrality associated with each node in first/second/third set of nodes and a count of nodes in said first/second/third set of nodes, wherein said degree centrality associated with said each node in said first/second/third set of nodes corresponds to a count of said one or more edges associated with respective node.

8. The method of claim 5 further comprising determining, by said one or more microprocessors, said core-to-periphery ratio of said one or more first/second graphs based on a ratio of a count of nodes with a degree greater or equal to two and a count of nodes with a degree less than two, in said respective graph, wherein said degree corresponds to a count of said one or more edges associated with respective node.

9. The method of claim 5 further comprising determining, by said one or more microprocessors, a weight associated with each of said one or more edges, wherein said weight corresponds to a degree of said association.

10. The method of claim 9 further comprising updating, by said one or more microprocessors, said weight based at least on a performance of said one or more workers in performing said one or more crowdsourcing tasks.

11. The method of claim 10 further comprising recommending, by said one or more microprocessors, said first set of workers, to work with, to said second set of workers, based on said updated weights.

12. The method of claim 11 further comprising updating, by said one or more microprocessors, said weight based on ratings provided by said first set of workers to said second set of workers.

13. The method of claim 1 further comprising creating, by said one or more microprocessors, a communication channel between said first set of workers and said second set of workers.

14. A system for determining one or more strategies in crowdsourcing, the system comprising:
one or more microprocessors configured to:
generate one or more first graphs representative of at least one of an association between one or more workers, between one or more crowdsourcing tasks, or between said one or more workers and said one or more crowdsourcing tasks, at a first time instance;
determine values of one or more metrics associated with said one or more first graphs;
compare said determined values of said one or more metrics and one or more threshold values of said one or more metrics;
generate, one or more second graphs based on said comparison, wherein said one or more second graphs are representative of at least one of said association between said one or more workers, between said one or more crowdsourcing tasks, or between said one or more workers and said one or more crowdsourcing tasks, at a second time instance, wherein said second time instance precedes said first time instance;
determine said one or more strategies based on said one or more second graphs, wherein said one or more strategies comprise at least one of:
a recommendation to a first set of workers, from said one or more workers, for attempting a first set of crowdsourcing tasks, from said one or more crowdsourcing tasks, or
a recommendation to said first set of workers for increasing interaction with a second set of workers; and
display said one or more strategies to a user through a user interface.

15. The system of claim 14, wherein said first set of workers and said second set of workers work on different stages of said one or more crowdsourcing tasks.

16. The system of claim 14, wherein said one or more metrics comprise at least one of a density of one or more first/second graphs, a centrality of said one or more first/second graphs, or a core-to-periphery ratio of said one or more first/second graphs, a clustering coefficient associated with said one or more first/second graphs, or path length associated said one or more first/second graphs.

17. The system of claim 14, wherein said one or more first graphs and said one or more second graphs comprises a first set of nodes depicting said first set of workers, a second set of nodes depicting said second set of workers and a third set of nodes depicting said one or more crowdsourcing tasks.

18. The system of claim 17, wherein at least one of said first set of nodes, said second set of nodes, and said third set of nodes are interconnected by one or more edges depicting said association.

19. The system of claim 18, wherein said one or more microprocessors are further configured to determine said density of said one or more first/second graphs based on a ratio of a count of said one or more edges in respective graph and a maximum count of said one or more edges to connect respective set of nodes.

20. The system of claim 18, wherein said one or more microprocessors are further configured to determine said centrality of said one or more first/second graphs based at least on a degree centrality associated with each node in first/second/third set of nodes and a count of nodes in said first/second/third set of nodes, wherein said degree centrality associated with each node in said first/second/third set of nodes corresponds to a count of said one or more edges associated with respective node.

21. The system of claim 18, wherein said one or more microprocessors are further configured to determine said core-to-periphery ratio of said one or more first/second graphs based on a ratio of a count of nodes with a degree greater or equal to two and a count of nodes with a degree less than two, in said respective graph, wherein said degree corresponds to a count of said one or more edges associated with respective node.

22. The system of claim 18, wherein said one or more microprocessors are further configured to determine a weight associated with each of said one or more edges, wherein said weight corresponds to a degree of said association.

23. The system of claim 22, wherein said one or more microprocessors are further configured to update said weight based at least on a performance of said one or more workers in performing said one or more crowdsourcing tasks.

24. The system of claim 23, wherein said one or more microprocessors are further configured to recommend said first set of workers, to work with, to said second set of workers, based on said updated weights.

25. The system of claim 24, wherein said one or more microprocessors are further configured to update said weight based on ratings provided by said first set of workers to said second set of workers.

26. The system of claim 14, wherein said one or more microprocessors are further configured to create a communication channel between said first set of workers and said second set of workers.

27. A computer program product for use with a computer, the computer program product comprising a non-transitory computer readable medium, wherein the non-transitory computer readable medium stores a computer program code for determining one or more strategies in crowdsourcing, wherein the computer program code is executable by one or more microprocessors to:
generate, by one or more microprocessors, one or more first graphs representative of at least one of an association between one or more workers, between one or more crowdsourcing tasks, or between said one or more workers and said one or more crowdsourcing tasks, at a first time instance;
determine, by said one or more microprocessors, values of one or more metrics associated with said one or more first graphs;
compare, by said one or more microprocessors, said determined values of said one or more metrics and one or more threshold values of said one or more metrics;
generate, by said one or more microprocessors, one or more second graphs based on said comparison, wherein said one or more second graphs are representative of at least one of said association between said one or more workers, between said one or more crowdsourcing tasks, or between said one or more workers and said one or more crowdsourcing tasks, at a second time instance, wherein said second time instance precedes said first time instance;
determine, by said one or more microprocessors, said one or more strategies based on said one or more second graphs, wherein said one or more strategies comprise at least one of:
a recommendation to a first set of workers, from said one or more workers, for attempting a first set of crowdsourcing tasks, from said one or more crowdsourcing tasks, or
a recommendation to said first set of workers for increasing interaction with a second set of workers; and
display, by a display screen, said one or more strategies to a user through a user interface.
